(19) United States
(12) Patent Application Publication
(10) Pub. No.: US 2026/0122051 A1
(43) Pub. Date: Apr. 30, 2026

(54) SYSTEMS AND METHODS OF DEVICE PROVISIONING FOR BUILDING MANAGEMENT SYSTEMS

(71) Applicant: Tyco Fire & Security GmbH, Neuhausen am Rheinfall (CH)

(72) Inventors: Justin Seifi, Cedarburg, WI (US); Gary Gavin, Franklin, WI (US); Matthias Walczyk, Duesseldorf (DE); Paul Vincent, Cork (IE); John Jilek, Grafton, WI (US)

(21) Appl. No.: 18/930,971

(22) Filed: Oct. 29, 2024

(51) Int. Cl. H04L 9/40

(52) U.S. Cl. CPC H04L 63/0823; H04L 63/029; H04L 63/108

(57) ABSTRACT

Systems and methods for device provisioning may include a second device which communicates, to an API of one or more servers, prior to an expiration time corresponding to a first request from a first device, credentials corresponding to a unique identifier included in the first request, and a second request for a signed certificate. The second device may receive, from the one or more servers via the API, a response to the second request including the signed certificate. The second device may establish, using the signed certificate, a virtual tunnel to communicate with a remote resource. The second device may update, using the remote resource, one or more provisioned resources of the second device.

### BACKGROUND

The present disclosure relates generally to device authentication. More specifically, the present disclosure relates to systems and methods for device authentication of devices/components/hardware of a building management system.

A building management system (BMS) is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area).

A BMS may include one or more computer systems (e.g., servers, BMS controllers, etc.) that serve as enterprise level controllers, application or data servers, head nodes, supervisory controllers, or field controllers for the BMS. Such computer systems may communicate with multiple downstream building systems or subsystems (e.g., an HVAC system, a security system, etc.) according to like or disparate protocols (e.g., LON, BACnet, Ethernet, etc.).

### SUMMARY

Some resources may be disposed remote from a device to be provisioned. For example, a newly manufactured or re-imaged device may be separated from a private network of a provisioning resource by a public network such as the internet. Although various techniques use certificates, keys, or other credentials to establish secure communications channels using public networks, secure delivery of these credentials over a public network can risk inadvertent propagation of these credentials. Provisioning devices upon their manufacture, update, installation, or other use can aid subsequent operations related to updates, management, or security of a device. Such devices may originate from networks apart from a provisioning server, as in the case of a remote manufacturing facility or installation location. Authentication or provisioning of such devices while preventing authentication or provisioning of unauthorized devices can prove challenging.

In one aspect, this disclosure is directed to a method of device authentication. The method may include communicating, by a second device, to an API of one or more servers, prior to an expiration time corresponding to a first request from a first device, credentials corresponding to a unique identifier included in the first request, and a second request for a signed certificate. The method may include receiving, by the second device from the one or more servers via the API, a response to the second request including the signed certificate. The method may include establishing, by the second device, using the signed certificate, a virtual tunnel to communicate with a remote resource. The method may include updating, by the second device using the remote resource, one or more provisioned resources of the second device.

In some embodiments, the first device establishes a shared secret with the one or more servers prior to the first request. The shared secret can expire at a second expiration time. A communications channel for the first request may be established using the shared secret. In some embodiments, the provisioned resources include multiple shared secrets and application installations. In some embodiments, the communications between the second device and the one or more servers for the API are provided over a public network. In some embodiments, communicating the second request includes communicating, by the second device, the second request to the API automatically responsive to an execution of a startup sequence of the second device. The startup sequence can include a suboperation to prevent an execution of the startup sequence upon a completion of the startup sequence.

In some embodiments, the method includes verifying, by the second device, responsive to a second execution of the startup sequence, a state of a plurality of sequential suboperations of the startup sequence to update the one or more provisioned resources. The method can include resuming, by the second device, responsive to detecting an uncompleted suboperation of the sequential suboperations, the sequential suboperations to update the one or more provisioned resources. In some embodiments, the method includes retrieving, by the second device, a first portion of the credentials from a non-volatile hardware-embedded unique identifier of an application specific hardware device local to the second device. The method can include retrieving, via a network interface, a second portion of the credentials remote from the second device. In some embodiments, the method includes determining, by the server, a status of the signed certificate and reverting, responsive to the determination, the updates of the one or more provisioned resources. In some embodiments, the API determines a status of the signed certificate and reverts the updates to the one or more provisioned resources based on the status

In one aspect, this disclosure is directed to a server including one or more processors. The one or more processors may be configured to receive, from a first device, a first request including a unique identifier, the first request corresponding to an expiration time. The one or more processors may be configured to receive from a second device, prior to the expiration time, a credential corresponding to the unique identifier and a second request for a signed certificate. The one or more processors may be configured to issue, responsive to the receipt of the credential prior to the expiration time, a signed certificate.

In some embodiments, the one or more processors are configured to establish, over a public network, a virtual tunnel to communicate with the second device and update, using the virtual tunnel, one or more provisioned resources of the second device. In some embodiments, the one or more processors are configured to close, prior to the expiration time, a window for the second request defined according to the first request, responsive to a receipt of the credential. The one or more processors may be configured to log any subsequent requests to sign a certificate. In some embodiments, the credential includes a credential of an application-specific hardware device. In some embodiments, the one or more processors are configured to establish a secure connection using a shared secret between the first device and the server prior to the receipt of the first request.

In some embodiments, the one or more processors are configured to receive, from the second device in a deployed configuration, a third request to renew a certificate. The one or more processors may be configured to provide, to the second device, a second signed certificate responsive to the third request. In some embodiments, the signed certificate is a mutual transport layer security certificate established between the server and the second device. In some embodiments, the one or more processors are configured to revoke, prior to a predefined expiration time, the signed certificate of the second device. In some embodiments, the one or more processors are configured to determine an authorization status of the second device responsive to a match between a first and second portion of the credential. The one or more processors may be configured to determine revocation status of the credential. The one or more processors may be configured to issue the signed certificate based on the authorization status.

In some embodiments, the server includes a device commissioning server configured to communicate with the second device. The server can include a certificate issuance server configured to generate the signed certificate. The server can include a data repository configured to maintain a record of communication between the device commissioning server and the second device.

In one aspect, this disclosure is directed to a system. The system includes a first server including one or more first processors. The first processors may be configured to receive, prior to an expiration of a temporal window negotiated between the first server and a first device, a request from a second device. The first processors can be configured to forward a signed certificate to the second device, the signed certificate received from a second server responsive to a communication of the request to the second server. The first processors may be configured to establish a virtual tunnel to communicate with the second device. The second server may include one or more second processors configured to generate the signed certificate responsive a receipt of the forwarded request from the first server.

In some embodiments, the first device is configured to receive, from the second device, an automatically generated communication including the request, an international globally unique identifier (IGUID), and a serial number. At least one of the IGUID or the serial number may be embedded in an application-specific hardware device of the second device.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a building management system (BMS), according to some embodiments.

FIG. 2 is a block diagram of a system that authenticates devices, such as devices of the BMS of FIG. 1, according to some embodiments.

FIG. 3 is a block diagram of an example device of FIG. 2, according to some embodiments.

FIG. 4 is a sequence diagram for an authentication or provisioning of the device of FIG. 3, according to some embodiments.

FIG. 5 is a swim lane diagram illustrating an example method of device commissioning, according to some embodiments.

FIG. 6 is a flow diagram illustrating an example method of device commissioning, according to some embodiments.

### DETAILED DESCRIPTION

### Overview

Referring generally to the figures, systems and methods devices can be provisioned in accordance with the present disclosure. The devices may be provisioned for use in building management systems, or other distributed systems which may be disposed remote from a provisioning server. For example, the devices may be distributed among various installation locations, but may advantageously maintain network communication with one or more remote resources of a private network.

More particularly, a device may be associated with a first entity having a first network (e.g., corporate intranet). The first entity can include, for example, a software provider, and/or may include an OEM (original equipment manufacturer) of the device. The device may further be associated with a second entity having a second network. The second entity can include, for example, a manufacturing facility for the device. The second entity may include an OEM subnet or other segmented network or a contract manufacturer having a separate corporate intranet. In either case, the first network and the second network can be separated by a public network such as the internet 201. The device may further be associated with a third entity having a third network. For example, the third entity can include an installation location (e.g., customer site). The third network can also be separated from the first network by the public network.

In some implementations, the device may be configured to communicate with a resource of the first network while disposed on either of the second network or the third network. For example, upon manufacture, the device may be provisioned with various identifiers, secrets, or software applications. During use, at the installation location, the device may be configured to receive updates, such as software application updates or renewals of various credentials. For example, a resource of the first network can provide security or functionality updates, retrieve error logs as may be used to improve operations of the BMS, or resolve configuration issues. However, providing access to resources of a private network, such as the first network, if not appropriately implemented, can expose the remote resources, along with various other devices of the first network, to various attackers of a public network (e.g., the internet 201). Accordingly, systems and methods of the present disclosure are provided to manage the provisioning of devices, including provisioning resources as may aid devices to access a private network (e.g., the first network), while mitigating such risks.

Devices may be manufactured including one or more indications of unique identity. For example, the indications can include a unique identifier, as may be implemented according to an e-fuse, strapping resistor, microcode, or other embedded indication of identity. Further, the device may include or be associated with a serial number, batch number, date time group of manufacture (e.g., time of completion of an end of line test). Such a value may be determined, generated, or received by a trusted device associated with the manufactured device, and stored locally or otherwise accessible to the device itself. For example, the trusted device may be, include, or be in communication with an EOL test computer or other network connected machine as may be in communication with the device. In some embodiments, the trusted device can be provisioned with a username and password or other credential for communications (e.g., secured communications) with the remote resources of the first network.

The network connected machine (e.g., a trusted device) can provide a reservation request to a resource (e.g., an API) of the first network. The reservation request can indicate an identity of the devices (e.g., in a batch list including serial numbers or other identifiers of devices configured to communicate during the pendency of the window). The receipt of the reservation request, by the API, can initiate a timer corresponding to a temporal communications window for the device. The device can provide a message to the API during the pendency of the window. The message can include a request to provision the devices with software, tokens, credential, or certificate. For example, the message can include a certificate signing request.

The message can include a further credential to validate the identity of the device. For example, the device can provide a secret, such as the hardware embedded identifier and the serial number or identifier provided by the network connected machine. Accordingly, even as communicated across a public network such as the internet, the device identity can be validated. For example, the API can be configured to compare the secret to a local copy of the secret. In some embodiments, the provisioning can include a provision of a singed security certificate or other key of a key pair to establish a secure communications channel with a remote resource of or related to the API (e.g., a virtual tunnel). Provisioning can be performed over a public network to provide a certificate (e.g., a mutual transport level security, mTLS certificate). The device can use the certificate to establish the virtual tunnel, over which the device can interface with the API to provision further resources, such as software updates, installation packages, or other credentials.

### Building and Building Management System

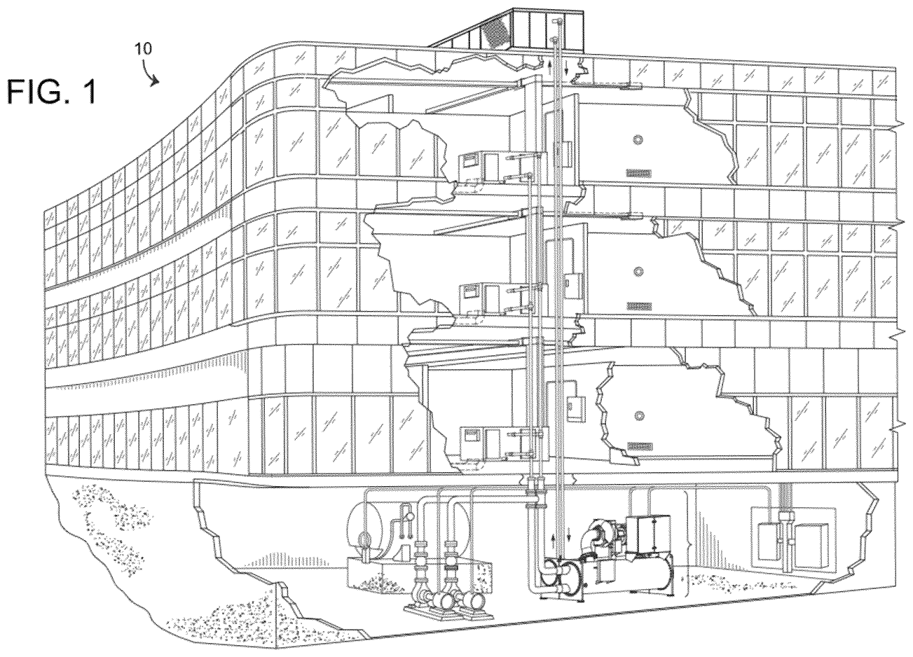

Referring now to FIG. 1, a perspective view of a building 10 is shown, according to an exemplary embodiment. A BMS serves building 10. The BMS for building 10 may include any number or type of devices that serve building 10. For example, each floor may include one or more security devices, video surveillance cameras, fire detectors, smoke detectors, lighting systems, HVAC systems, or other building systems or devices. In modern BMSs, BMS devices can exist on different networks within the building (e.g., one or more wireless networks, one or more wired networks, etc.) and yet serve the same building space or control loop. For example, BMS devices may be connected to different communications networks or field controllers even if the devices serve the same area (e.g., floor, conference room, building zone, tenant area, etc.) or purpose (e.g., security, ventilation, cooling, heating, etc.).

BMS devices may collectively or individually be referred to as building equipment. Building equipment may include any number or type of BMS devices within or around building 10. For example, building equipment may include controllers, chillers, rooftop units, fire and security systems, elevator systems, thermostats, lighting, serviceable equipment (e.g., vending machines), and/or any other type of equipment that can be used to control, automate, or otherwise contribute to an environment, state, or condition of building 10. The terms “BMS devices,” “BMS device” and “building equipment” are used interchangeably throughout this disclosure.

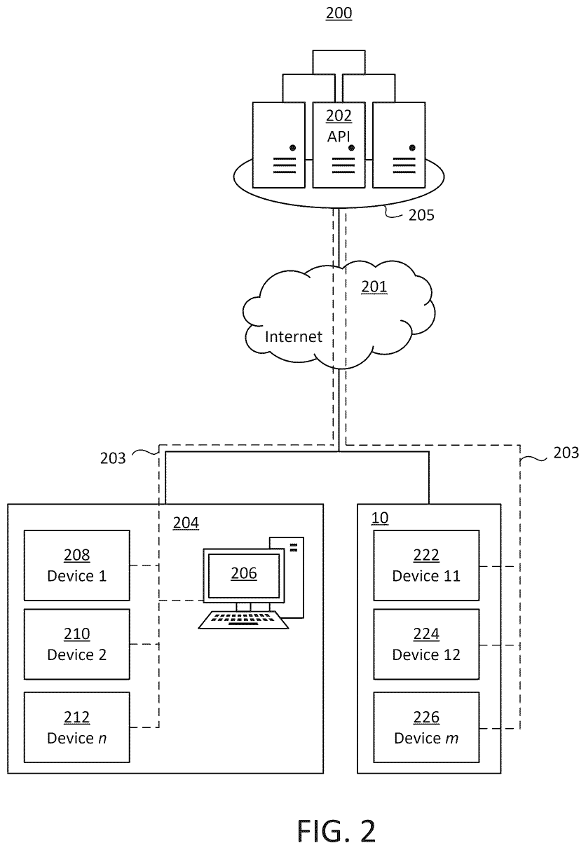

Referring now to FIG. 2, a block diagram of a system 200 to authenticate devices is provided, according to some embodiments. The devices can include one or more devices of a BMS of the building 10 of FIG. 1, or can be included at another location, such as a manufacturing facility.

An API 202 may be implemented by one or more servers. For example, the one or more servers can refer to single server, server bank/distributed servers as cloud deployment, hosted instances of a managed services platform, or other local, cloud, or hybrid implementation. Various functions of the server can be distributed across multiple servers, including one or more on premise servers, one or more cloud-based servers, and/or various combinations thereof. The API 202 can include a Representational State Transfer (REST) API, a Simple Object Access Protocol (SOAP) API or other architectures. The one or more servers implementing the API may be disposed on a private network 205, such as a corporate intranet. Various devices such as a first device 208, second device 210, and third device 212 may be disposed remote from such a private network 205. For example, the various devices 208, 210, 212 can be disposed at a remote location 204 corresponding to a public network or another private network, and may be connected with the private network 205 of the API 202 over the internet 201.

As used herein, the remote location 204 may refer to or include a location which is logically remote from a private network 205 of one or more host devices implementing the API 202. Such a logically remote location 204 can include a separate network or a segmented/firewalled portion of a same network. In many embodiments, the remote location 204 may be physically remote from any of various servers implementing the API 202. For example, the various devices 208, 210, 212 can be disposed at a manufacturing location apart from the private network 205 of the servers. In some cases, the remote location 204 and the hosts for the API 202 may be in different countries, or otherwise be associated with varying physical and network security environments. Accordingly, such a network configuration can be implemented to avoid extending a private network 205 to a location of the devices 208, 210, 212. In some embodiments, as in the case of a contract manufacturer of the devices 208, 210, 212, the network architecture may be implemented to avoid propagating remote access permission.

The remote location 204 should not be construed to require physical separation between the devices 208, 210, 212 and the servers for the API 202. In some embodiments, the various components of the block diagram may be physically located at a same city, campus, building, or other facility. For example, the implementation can correspond to a segmented network implementation of a same entity.

Another location (again, referring to a logical or network location), can include further devices. For example, various devices may be disposed in a building 10, as in the case of various devices of a BMS system. Particularly, a fourth device 222, fifth device 224, and sixth device 226 are depicted as constituent to a BMS system of the building 10, and more particularly, to a network or network segment corresponding to the building 10. Such devices may be referred to as disposed in a deployed configuration. The fourth device 222, fifth device 224, and sixth device 226 may have been previously commissioned (e.g., provisioned, or otherwise authenticated) via the API 202 or according to other approaches. Accordingly, such devices 222, 224, 226 may be referred to generally as previously authenticated devices.

By contrast to the previously authenticated devices, the first device 208, second device 210, and third device 212 may not have been previously commissioned, provisioned, or otherwise authenticated by the API. For example, where the remote location 204 corresponds to a manufacturing facility for the devices, 208, 210, 212, said devices may be in a factory state (e.g., bare metal, or otherwise unconfigured). Accordingly, such devices 208, 210, 212 may be referred to generally as unauthenticated devices. Because the API 202 may cause a provisioning record to be generated upon provisioning, even upon returning a previously authenticated device to a factory state, the provisioning of such a device can vary from the unauthenticated device, according to some embodiments of the present disclosure.

The remote location 204 includes one or more provisioning devices 206 configured to interface with the API 202. As for the API 202, the provisioning may be performed by one or more devices, any of which may perform all or a subset of the operations referred to with regard to the provisioning devices 206. In some embodiments, the building 10 may include further provisioning devices 206, as may be configured to execute at least some of the operations of the provisioning devices 206 of the remote location 204. For example, such a provisioning device 206 may be configured to execute all such operations, or a subset of the operations, according to a difference between an original and subsequent provisioning (e.g., after a factory reset) as may vary according to the provisioning record referred to above. In some embodiments, such a subset of operations can include acting as a gateway device to establish an operative connection with the API 202. The establishment of the connection or other communications with the API 202 may be achieved via communication with one or more servers acting as a host for the API. For brevity of the disclosure, communication with any such server or other host related to API operation is sometimes referred to as communication with “the API 202.”

Referring further to the provisioning device 206 of the remote location 204, the provisioning device 206 can establish a connection with the API 202. The connection can be established according to a conveyance of a username and password or other credentials from the provisioning device 206 to the API 202. The provisioning device 206 can provide an indication of an identity of one or more devices for provisioning (e.g., the unauthenticated devices). For example, the provisioning device 206 can provide a list of serial numbers of unauthenticated devices. Upon receipt of the identifiers, the API 202 can start a timer. Prior to an expiration of the timer, the API 202 can receive, from the unauthenticated devices, the previously provided indication of identity along with a further symbolic token to confirm such an identity, which may be provided according to an embedded hardware identifier, such as an e-fuse or other chip-based identity. In this way, even where the communication between the provisioning device 206 and the API 202 is compromised, a machine-in-the-middle (MITM) would not generally be able to provide such an identifier.

Where the API does not detect anomalies associated with the credentials provided by an unauthenticated device, the API 202 can determine that the device is authenticated. The anomalies can refer to, for example, duplicate requests, mismatches between serial numbers and other credentials, or receipts of requests relating to serial numbers for which no reservation request exists, or for which a reservation request has expired. Upon device authentication, the API 202 can execute further actions to provision the device, such as by signing certificates, providing keys, credentials or other tokens, conveying software application packages, or so forth. In some embodiments, such provisioning may be specific to the device as determined based on the identifier. For example, the API can provide a first set of software application packages for a first device (e.g., a device having a model number or serial number of 123), and a second set of software application packages for a second device (e.g., a device having a model number or serial number of 124).

In the event that the API 202 detects an anomaly, such as where the timer expires prior to a receipt of the further symbolic token, an incorrect further symbolic token is provided, or repeated requests corresponding to a same unauthenticated device are received, the API 202 can inhibit certain operations, such as signing certificates, providing sensitive data, or so forth, or can generate notifications indicating the anomalous activity. In some embodiments, the API 202 may be configured to record any anomalies as a portion of the provisioning record.

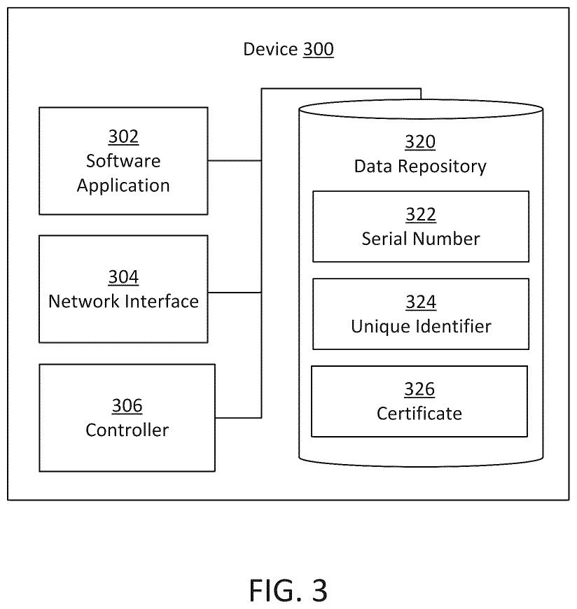

FIG. 3 is a block diagram of an example device 300, according to some embodiments. For example, the device 300 can be or include any of the previously authenticated devices or unauthenticated devices of FIG. 2 subsequent to an execution of various of the provisioning operations described herein. As is described in further detail with regard to the controller 306 henceforth, the various components of the device 300 can include hardware or software components. Accordingly, some devices 300 can omit certain components prior to completion of a provisioning process, but may be adapted to receive such components. For example, in some instances, a device 300 can omit a certificate or software applications prior to a provisioning process, as the provisioning process may provision such components. Further, various components of the device 300 may vary according to embodiments of the present disclosure, or between particular instances. For example, each device 300 can be provisioned with different components according to an intended use, and may map to a serial number, model number, or other identity associated with the device. A portion of, for example, software applications 302, certificates 326, or network interfaces 304 may be omitted, added, modified or substituted between devices (e.g., a variable air volume management device may include different software applications 302 than a lighting system).

The device 300 can include or be configured to interface with one or more software applications 302. The software application 302 can refer to or include instructions that, when executed by the controller 306, cause the device 300 to perform various operations or sub-operations. Software applications 302 may include operating systems or management applications. For example, one or more of the software applications can include identity and access management platforms, which may provide resources for sign on to services, device lifecycle management (e.g., provision, updates, or offboarding of other software applications 302), and the like.

Software applications 302 can include further instructions to implement device functionality. For example, where the device 300 is configured as a component of a BMS, the execution of instructions of the software applications 302 may cause the device 300 to report and/or adjust operations or conditions of the building 10.

Software applications 302 can include various management functions of the device 300, and need not be constrained to an applications level, as defined by the open systems interconnection (OSI) model. For example, the software applications 302 can include startup scripts that may be executed at every startup, or may be executed initially by an unauthenticated device. For example, the software applications 302 can include a script or other instructions configured to complete an authentication or other provisioning operation for the device.

The device 300 can include or be configured to couple with one or more network interfaces 304. A network interface 304 can include various components (e.g., circuits or instructions) configured to establish network connectivity with a counterpart device (e.g., the API 202 or other resources). For example, the network interface 304 can include a physical layer (PHY) for signal processing and modulation, as well as other components such as a Media Independent Interface (MII) to manage communication between various layers of a network stack. The network interface 304 can include protocols configured to communicate over the internet or locally (e.g., at the remote location, such as to communicate between a device and an end-of-line, EOL test computer). Some examples of protocols implemented by the network interface 304 include Ethernet, universal serial bus (USB), or serial connections.

The network interface 304 is configured to establish communication (e.g., secure communications) with various devices using digital certificates 326 to verify the identities of the communicating parties. These certificates 326, typically exchanged during a handshake process, contribute to indications that the device 300 and a counterparty device are trusted. Once authenticated, the network interface 304 can establish a port, socket, session, channel, or other communicative link to support communication. Protocols, such as TLS (Transport Layer Security), may be used during this process to encrypt data and protect the connection. After a link is established, the devices can exchange data, with the network interface 304 maintaining the link. The device can include any number of instances of the network interface 304, and may refer to any of a physical-level, session-level, or other level of operation.

The device 300 can include or be configured to interface with one or more controllers 306. The software application 302 and network interface 304 can each include or interface with at least one processing unit or other logic device, such as a programmable logic array engine or hardware of the controller 306, configured to communicate with a data repository 320 or database. The software application 302, network interface 304, and controller 306 can be separate components, a single component, or integral to the device 300. The device 300 can include hardware elements, such as one or more processors, logic devices, or circuits of the controller 306, as well as software components. For example, the hardware components can include dedicated circuits configured to execute particular functions, or can include a memory coupled with the one or more processors. Any of the instructions of the device 300 can refer to or include instructions stored on a non-transitory computer-readable memory, or another memory coupled with one or more processors of the controller 306. Such instructions can be configured for execution by the one or more processors of the controller 306.

The data repository 320 can include one or more local or distributed databases, and can include a database management system. The data repository 320 can include computer data storage or memory and can store one or more data structures, such as a data structure corresponding to any of various identifiers such as a serial number 322 and a hardware specific unique identifier 324 (e.g., an international globally unique identifier, IGUID). Further data structures can correspond to digital certificates 326.

A serial number 322 may refer to or include a unique number assigned to a device 300, to distinguish it from other devices 300. In some embodiments, a serial number 322 may be generated at a time of provisioning. For example, an end-of-line (EOL) machine can generate and assign the serial number 322 at provisioning time (e.g., incident to the generation of a reservation request, or printing a label including the serial number). In some embodiments, the serial number 322 can be pre-provisioned (similar to the other unique identifier 324). The serial number 322, like the unique identifier 324, the certificate 326, and other data elements of the present disclosure such as usernames and passwords, may be referred to, individually or collectively, as a credential. For example, a credential may refer to a serial number 322 alone, another unique identifier 324 alone, or a combination of the serial number 322 and the unique identifier 324.

In some instances, a serial number 322 or other aspect of a device 300 (e.g., the unique identifier 324) may be referred to as an identifier. Such an identifier can include, for example, the serial number 322, a MAC address, or other indication of identity of the device 300.

A unique identifier 324 may refer to or include a distinct value or code assigned to a device 300, which may be used to distinguish the device 300 from other devices 300. This identifier can take various forms, such as alphanumeric strings, numerical codes, or specific combinations of characters. In some embodiments, the unique identifier 324 is implemented as a globally unique identifier (GUID), which may be referred to as any of an IGUID or universally unique identifier (UUID) without limiting effect. For example, such an identifier can be provided as a 128-bit value that may be difficult to guess. In some embodiments, the unique identifier 324 is stored according to an application-specific hardware device, such as e-fuses, embedded microcode, strapping resistors, or so forth. In some embodiments, the unique identifier 324 can be dynamically generated, as in the case of a challenge-response approach, such which may be implemented in public key infrastructure implementations.

The unique identifier 324 can be used to verify an identity of a device 300, even when communicating over a public network that may be susceptible to eavesdropping. For example, the unique identifier 324 may be pre-shared between the API 202 and the remote device 300 (e.g., according to a predetermined data map for e-fuse or other data structure embedded into the device 300). For example, the API 202 can validate an identity of a device 300 based on knowledge of the unique identifier 324 (where the unique identifier 324 is a shared secret between the API 202 and the device 300).

In some embodiments, a relationship between the serial number 322 and another unique identifier 324 can be accessible to the API 202 prior to device provisioning (e.g., can be a shared secret therebetween). Accordingly, upon receipt of a serial number 322 matched with the unique identifier 324, the API 202 can compare the received data to known data to validate the identity of the device 300. In some embodiments, a relationship between the serial number 322 and another unique identifier 324 is not be accessible to the API 202 prior to device provisioning.

Accordingly, the API 202 can store a linkage between the serial number 322 and another unique identifier 324 as a portion of the provisioning record.

A certificate 326 may refer to or include an electronic document that uses a digital signature to bind a key (e.g., a public key) to an identity of a device. Signing the certificate 326 can refer to a use of a key to create a digital signature on the certificate 326. The signature may serve as a validation mechanism, confirming that the certificate was issued by its issuer and has not been altered since its issuance. The device 300 may, in turn, provide proof of possession of the certificate 326 as proof of identity. The issuer can include a private signatory (e.g., a resource of the API 202) or another resource (e.g., a third-party certificate authority).

In the case of a mutual TLS (mTLS) certificate, the certificate can authenticate both of a client and a server during the communication process. Each of the client and server can refer to either of the device 300 or the API 202. For example, the API 202 can operate as a server for the client-device 300 to download software application 302 or upload logfiles. The API 202 can operate as client for resources served (e.g., hosted) by the device 300, such as for operations of a BMS system. The mTLS certificate contains information about an identity, public key, or issuing certificate authority for the device 300 and API 202. This authentication mechanism aids the device 300 and API 202 to verify each other's identities before incident to establishing a secure connection.

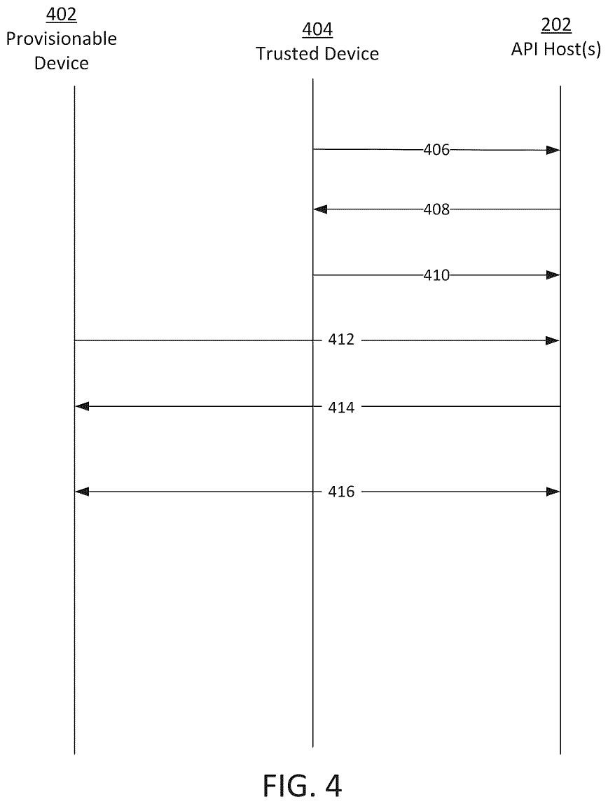

Referring now to FIG. 4, a sequence diagram 400 for a method for authentication or provisioning a provisionable device 402 is provided according to some embodiments. The provisionable device 402 can refer to or include the device 300 of FIG. 3. That is, the sequence diagram 400 can depict a method to provision any of the previously authenticated devices or unauthenticated devices of the present disclosure. The sequence diagram 400 can correspond to an environment including various components, such as is depicted in FIG. 1. More particularly, an illustrative example of a trusted device 404 communicatively coupled with the provisionable device 402 and the API 202 is provided. The trusted device 404 can refer to or include a provisioning device 206, in some embodiments. For example, the trusted device 404 can establish trust according to the execution of operations 406 and 408, henceforth. In some embodiments, the trusted device 404 can otherwise establish trust with the API 202 (e.g., according to a root of trust). Indeed, various of the operations provided herein may be omitted, added, substituted, or otherwise modified according to various embodiments of the present disclosure.

At operation 406, the trusted device 404 provides, to the API 202, an indication of an identity. For example, the indication can include a token such as a username and password, or evidence of possession of any of a public, private, or symmetric key. Upon receipt of the indication, the API 202 can determine an authorization of the trusted device 404. As described above, reference to the API 202 can refer to various servers configured to support resources of the API 202.

At operation 408, responsive to the receipt of the indication of an identity of operation 406, the API 202 can provide a token in response, or otherwise validate or generate a shared secret between the trusted device 404 and the API 202. That is, a shared secret between the trusted device 404 and the API 202 can refer to any of a pre-shared secret, such as a password or derivative thereof (e.g., a hash), the token (e.g., key of a key-pair), or so forth. In some embodiments, the shared secret can expire, such that the secret is renewed periodically to maintain or establish a communications channel between the trusted device 404 and the API 202.

At operation 410, the trusted device 404 provides a request (sometimes referred to as a reservation request, without limiting effect) to the API 202. For example, the trusted device 404 can provide the request over the communications channel established at operation 408. The request can identify at least one provisionable device 402. For example, the request can indicate a serial number 322, MAC address, or other identifier which may be used to identify the provisionable device 402. For example, in some embodiments, the provided identifier may be unique.

The request can correspond to an expiration time, in some embodiments. For example, the expiration time may be included in the request, or the API 202 can be configured to set a predefined expiration time upon a receipt of a valid request. A time between setting the expiration time (or an offset therefrom) and an expiration of the expiration time may be referred to as a temporal window for communication. For example, communication between the provisionable device 402 and the API 202 host can be restricted to such a window. In some embodiments, the API 202 is configured to close the window prior to the expiration time upon one or more communications with a provisionable device 402. For example, the API 202 can log subsequent requests (e.g., as potentially unauthorized requests, such as a MITM attack). In some embodiments, the API 202 may implement a delay between operations 410 and 412 to detect duplicate requests, to avoid providing a response to a MITM. The API 202 may be configured to execute various operations responsive to detected duplications, such as revocation of an associated certificate 326 or generation of a notification for the anomaly.

At operation 412, the provisionable device 402 (or provisionable devices 402, according to implementations providing multiple provisionable device 402 in the request of operation 406) provides another request to the API 202, prior to the expiration time or other closing of the window. The request of the present operation 412 can be automatically executed, such as according to an execution of a startup sequence (e.g., a script) of the provisionable devices 402. For example, the startup sequence can be integrated into an initial image for the provisionable device 402 (sometimes referred to as a “factory load” or “factory image”). Accordingly, upon a first boot or first connection to the internet, the provisionable device 402 may be configured to communicate the request to the API 202. The various components of the request of the present operation 412, like other operations of the present disclosure, can be provided according to a one or more packets, transmissions, or other communications.

The request of the present operation 412 can include credentials corresponding to, but different from, the identifier of the request of operation 410. For example, where the identifier provided by the trusted device 404 (at operation 410) includes a serial number 322, the credential provided corresponding to the serial number 322 can include a different unique identifier 324 (e.g., an IGUID). In some embodiments, the credential of the present operation 412 is embedded in an application-specific hardware device of the provisionable device 402 (e.g., as defined according to a e-fuse, strapping resistor, microcode of a controller 306, FPGA hardware identifier, or other credentials which may be provided as a portion of a root of trust of the device). In some embodiments, the provisionable device 402 can retrieve a first portion of the credentials from a non-volatile hardware-embedded unique identifier of an application specific hardware device local to the provisionable device 402. For example, the credentials can be provided according to an execution of instructions of a startup sequence. The provisionable device 402 can retrieve a serial number 322 or other second portion of the credential from a source remote therefrom (e.g., from the trusted device 404). For example, in the case of an EOL PC, the serial number 322 may be generated for, or assigned to, the provisionable device 402 by the trusted device 404. The provisionable device 402 can receive the serial number from the trusted device 404 via a network interface 304 which is not transmitted over a public network (e.g., via a serial or USB link).

The request of the present operation 412 may be provided over a public network (e.g., the Internet 201). Accordingly, the combination of a credential (e.g., the IGUID) and the previously communicated identifier (e.g., the serial number 322) can authenticate the provisionable device 402, since an attacker would not, generally, communicate a valid IGUID or a valid pair of an IGUID and serial number 322). Further, attempts to overwhelm or brute force attacks may be detected according to receipt, by the API 202, or duplicate or incorrect requests. Further, even in the event that a trusted device 404 is successfully compromised or spoofed, the provision of the request of operation 410 to the API 202 would not aid a spoofed provisionable device 402 to provide the further credential, where the credential is embedded in device hardware that may be inaccessible to the trusted device 404.

The request of the present operation 412 can include a request for a signed certificate, sometimes referred to as a certificate signing request (CSR), without limiting effect. For example, the request can include a certificate 326 or an identifier therefor. The signing of the certificate 326 can refer to a cryptographic application of a private key from an entity issuing the certificate 326. In some embodiments, the signing may refer to a remote registration of the certificate 326 (e.g., with a trusted third party) so that the authenticity of the certificate 326 may be validated with a public key. In some embodiments, the API 202 hosts can include or interface with a resource of a certificate signing authority.

At operation 414, the API 202 provides, to the provisionable device 402, a response to the request of operation 412 including at least a signed certificate 326. As described above, the signed certificate 326 can be provided responsive to the receipt of the credential of operation 412 prior to the expiration time (or prior to another closing of the window, such as responsive to a detection of anomalous behavior).

The signed certificate 326 can include a certificate 326 to generate a virtual tunnel 203 with a resource remote to the provisionable device 402. For example, such a certificate 326 can include a mutual transport layer security certificate (mTLS) 326 between the provisionable device 402 and the remote resource. In some embodiments, the remote resource is a resource of the API 202, so that the mTLS or other certificate is particular to communication between the provisionable device 402 and the API 202. In some embodiments, the API 202 is configured to determine an authorization status of the CSR responsive to determining a revocation status of the credential (e.g., comparing a serial number 322, GUID, or other identifier of the credential to an access list or a block list). In some embodiments, the API 202 is configured to determine an authorization status of the CSR responsive to identifying a match between separate portions (e.g., a first portion and second portion) of the received credentials. For example, where a received IGUID or other identifier does not match an expected IGUID for a serial number 322, the API 202 can determine the authorization is not valid, and log the discrepancy, generate a notification of the discrepancy, or take another action. Conversely, where the CSR authorization is valid, the API 202 can issue the signed certificate responsive to the authorization status.

In some embodiments, the API 202 is configured to generate the signed certificate according to communication with a certificate issuance server. For example, the hosts or other resources of the API 202 can include a device commissioning server configured to communicate with provisionable devices 402, and include or interface with a native or third-party certificate issuance server configured to generate the signed certificate (e.g., cryptographically sign, register, or otherwise validate the certificate). The device commissioning server can forward a signed certificate (or indication thereof) to the provisionable device 402 responsive to a signing action executed by the certificate issuance server.

At operation 416, the provisionable device 402 establishes a virtual tunnel 203 to communicate with a remote resource using the signed certificate (e.g., the mTLS certificate). The provisionable device 402 can continue to receive information via the virtual tunnel 203 information from one or more provisioned resources, and update itself using such a communicative connection. For example, the update can include application installations or adjustments to software applications, or a provision of shared secrets which may be used to communicate with further remote resources. In some embodiments, the API 202 (or other remote resource) is configured to determine a status of the singed certificate (e.g., valid, invalid, expired, etc.). The remote resource can revert or otherwise adjust the updates based on the certificate (e.g., push an older version of a software application 302, such as a factory image).

Although depicted as executed according to communication between the provisionable device 402 and the API 202, the virtual tunnel 203 of FIG. 2 may be established at operations 412 and 414 and can include communication with further remote resources. Accordingly, the provisionable device 402 can communicate with all or a subset of the remote resources via a communications channel other than the API 202. For examples, the signed certificates 326 can include various certificates 326 for various communications channels, such as for secure file transfer protocol (sFTP) communication or secure shell communication (SSH). In some embodiments, the provisionable device 402 receives additional certificates, passwords, or other credentials to access such further remote resources via the virtual tunnel 203 with the API 202, and connects to such remote resources for further provisioning operations, subsequent to operation 414.

In some embodiments, the provisionable device 402 is configured to execute the method for authentication and provisioning according to a startup sequence including individually executable sequential suboperations. For example, the provisionable device 402 can execute a script including the executable suboperations, and locally store an indication of completion or non-completion of each suboperation. Accordingly, if the provisionable device 402 loses power, network connectivity, or the execution of the series of steps is otherwise interrupted, the provisionable device 402 can verify a state of the various suboperations and resume the sequence preventing re-execution of completed suboperations, or omitting uncompleted suboperations. Such a sequence can include retries, failover conditions and instructions, and so forth.

The sequence of operations can be executed automatically at boot to provision of the provisionable device 402, or generate notification of non-completion (e.g., error reports or logs). The example, a communication of the present disclosure may be implemented as an automatically generated communication executed upon a first boot. In some embodiments, the error reports or logs can include counters to indicate a number of times the sequence or particular suboperations have been attempted. The provisionable device 402 can be configured to modulate suboperations based on counters. For example, the provisionable device 402 can be configured to attempt provisioning suboperations a predefined number of times before abandoning the attempt (e.g., reverting to a factory image, generating a notification for presentation to a user, or otherwise interrupting subsequent attempts).

In some embodiments, the API 202 maintains a record of communications or data exchanged with a provisionable device 402. Such a record can aid to provision the provisionable device 402, or otherwise manage communications, such as to detect MITM attacks or duplicate requests. Indeed, the API 202 can maintain a provisioning record (e.g., log) of any communication with a provisionable device 402.

The depicted and described operations (and suboperations) are provided according to an illustrative example of sequences. Such a disclosure should not be construed as limiting. For example, the operations of the API 202, provisionable device 402, trusted device 404, or other components of the present disclosure can include additional, fewer, or different operations. For example, the API 202 may be configured to communicate with provisioned devices in a building 10, subsequent to initial provisioning. Such communications can include, for example, managing certificate renewal responsive to requests from provisionable devices 402 or revocation of such licenses prior to a scheduled expiration as in the case of a detection of anomalous behavior. Such anomalous behavior can include, for example, detection that a provisionable (provisioned) device 402 is faulty and should be reimaged to restore operation, that the device is compromised and in use propagating a distributed denial of service (DDOS) attack, or other unauthorized uses.

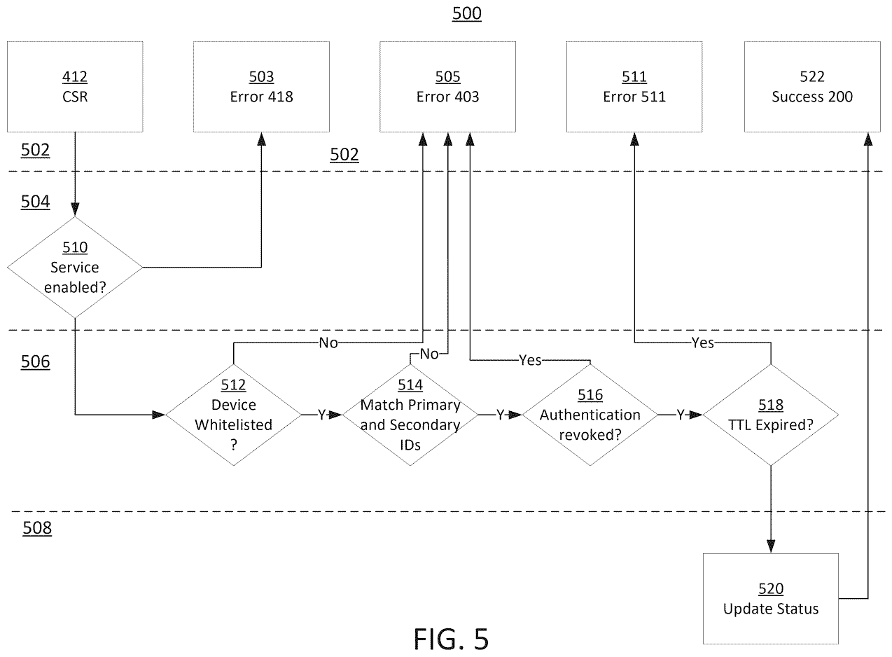

FIG. 5 is a swim lane diagram 500 illustrating an example method of device commissioning, according to some embodiments. For example, the swim lane diagram 500 can depict operations performed by the API 202 responsive to a receipt of the CSR from the provisionable device 402 (e.g., responsive to operation 412 of the sequence diagram 400 of FIG. 4). The example method may be provided subsequent to a receipt of a reservation request identifying the provisionable device 402, though such an embodiment should not be construed as limiting the present disclosure.

A first swim lane 502 depicts interfaces between the API 202 and associated resources. The first swim lane 502 includes the CSR, with reference to operation 412 as a nonlimiting illustrative example, as well as various status messages which may be returned to a provisionable device 402 according to an execution of the present method.

A second swim lane 504 depicts service checks 510 which may be performed by the API 202 upon a receipt of the CSR 412. The provisionable device 402 can be configured to determine an error if the API 202 does not receive or acknowledge the receipt of the CSR 412 upon an expiration of a time-out window. Where the API receives the CSR 412, the API 202 can validate that various hosts or resources are in an active state, and enabled. Where a recipient of the CSR 412 is able to communicate with further API resources and confirm their active status, the method can proceed to operation 512. Where the device is not enabled, or where the intra-API communication fails (e.g., times out), the API 202 can return a first error code 503, such as error code “418”according to a hypertext transport protocol (HTTP) implementation.

A third swim lane 506 depicts device checks which may be performed by the API 202 upon a completion of the service check 510. At operation 512, the API 202 verifies an identity of one or more identifiers. For example, the API 202 can verify the identity of a serial number 322 is valid, and provided according to an allow list (sometimes referred to as a whitelist). In some embodiments, the allow list is based on a receipt of a list of one or more devices 300 received from a trusted device 404 (e.g., the reservation request of operation 410). The API 202 can further verify a match between the identifier for the allow list and a further identifier at operation 514 (e.g., between the serial number and a hardware-based identifier, which may be implemented as an IGUID). The API 202 can further verify that authentication has not been revoked at operation 516. A failure of any of operations 512, 514, and 516 can cause the API 202 to convey a second error code 505 corresponding to a device-identity issue (e.g., a “403 forbidden” error code in an HTTP implementation). Such a failure can refer to any of a non-match of an identifier with an allow list, a non-match of corresponding identifiers, or a determination of revoked authentication.

Referring further to the third swim lane 506, the API 202 can validate a non-expiration of a window for the CSR at operation 518. Where the window is expired, the API 202 can return a third error code 511 to the provisionable device 402. For example, the API 202 can return a “410 gone” error code in an HTTP implementation. The sequence of various operations of the present disclosure may be sequenced differently than provided herein, in some embodiments. For example, operation 518 may be conducted prior to (or simultaneously with) any of operations 512, 514, or 516, which may mitigate a risk of API processing time causing the CSR request to expire. Similarly, operations 512, 514, or 516 may be performed concurrently or according to another order. In some embodiments, an error code may not be communicated to the provisionable device 402, such as according to an errant condition of the API 202 or where an error code is intentionally withheld for security reasons (e.g., to avoid informing a potential attacker of a particular failure mode).

A fourth swim lane 508 depicts status updates which may be performed by the API 202 or a repository communicatively coupled with the API 202. Such a repository may be separate from the data repository 320 of the device 300, and used to store API-side provisioning records, as referred to herein. For example, the provisioning records may be stored on a same private network 205 as the API 202, or otherwise be remote from the provisionable device 402. At operation 520, the API 202 or another device in network communication therewith, (e.g., the repository) can store any provisioning records generated associated with the provisioning records. The provisioning records may be used (e.g., by the API 202) to manage various aspects of a device lifecycle, such as reimaging or other provisioning of software updates. Upon or concurrent to such an update, the API 202 can provide an indication of success 522 to the provisionable device 402. For example, the API 202 can return a “200 success” code in an HTTP implementation.

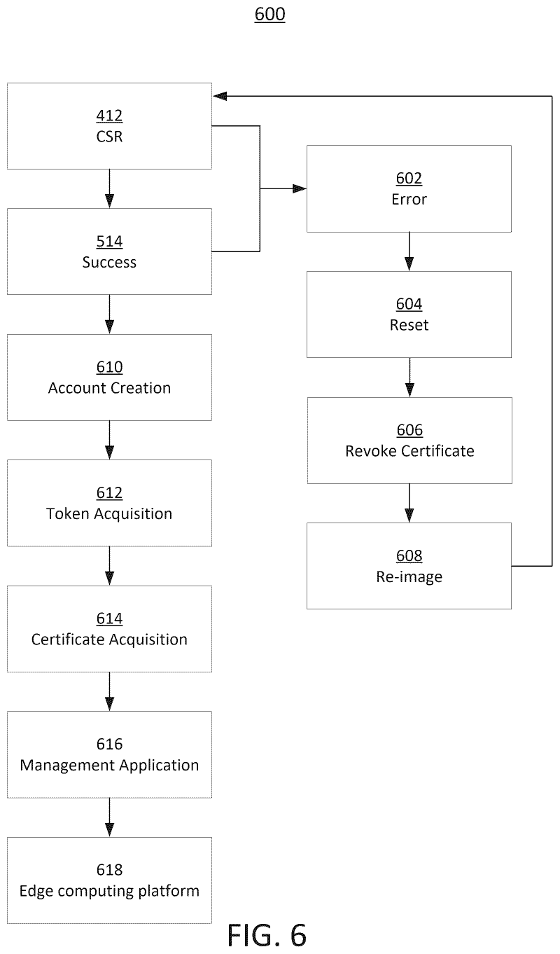

FIG. 6 is a flow diagram 600 illustrating an example method of device commissioning, according to some embodiments. The method begins with a provision of a CSR from a provisionable device 402 to an API 202. Where the provisionable device 402 detects an error, such as where the API 202 returns an error code, the method proceeds to an error pathway entry operation 602. In some embodiments (not depicted), the error pathway entry operation 602 can include a return path to the CSR 412 without execution of intervening operations of the error pathway. For example, responsive to a receipt of an error, the provisionable device 402 can attempt a second or third CSR 412 prior to proceeding to operation 602. The error pathway can further include resetting a provisionable device 402 at operation 604, revoking a certificate of the provisionable device 402 at operation 606, and re-imaging the provisionable device 402 at operation 608. The re-imaged device can return to operation 412 upon re-imaging. In some embodiments, a further counter can limit a number of cycles of the error pathway before communicating further CSR 412 with the API 202.

Where the provisionable device 402 receives an indication of success 522 from the API 202, the provisionable device 402 can proceed to create an account at operation 610. For example, the provisionable device 402 can create an account of an identity and access management service, which may be used to execute further of the operations of the present method. The account creation can include a generation or receipt of credentials for the identity and access management service (e.g., a username and password). Further, such credentials may be used for other of the operations of the present method.

At operation 612, the provisionable device 402 acquires a token (e.g., a JSON web token, JWT). For example, the token can authenticate the device, such as by using the signed certificate 326 received incident to the CSR 412, or the credentials for the identity and access management service of operation 610. The provisionable device 402 may be configured to generate the token locally, or via communication with one or more remote resources (e.g., the API 202 or another resource).

At operation 614, the provisionable device 402 acquires a credential using the token of operation 612. In some embodiments, this credential is the signed certificate 326 of operation 414. That is, operation 414 can include or relate to any of operations 610, 612, and 614 of the present method. As indicated above, in some embodiments, the signed certificate is an mTLS certificate for the provisionable device 402 and a remote resource (e.g., a remote resource of the API 202).

At operation 614, the provisionable device 402 provisions an edge gateway software application 302. For example, the edge gateway software application 302 can be configured to interface with various systems and devices of the building 10 which may aid in intercommunication therebetween, as well as with various remote resources. At operation 616, the provisionable device 402 can provision further software applications 302, which may be used for edge computing, sometimes referred to as fog computing, or complex event processing (e.g., artificial intelligence, AI analytics).

The provisionable device 402 can provision additional, fewer of different software applications 302 as well as various tokens, keys, or other shared secrets according to a functionality thereof. In some embodiments, either of the provisionable device 402 or the API 202 is configured to select a set of resources to provision based on an identity of the provisionable device 402, which may be determined based one or more identifiers thereof.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps

What is claimed is:

1. A method of device authentication comprising:
communicating, by a second device, to an API of one or more servers, prior to an expiration time corresponding to a first request from a first device, credentials corresponding to a unique identifier included in the first request, and a second request for a signed certificate;
receiving, by the second device from the one or more servers via the API, a response to the second request including the signed certificate;
establishing, by the second device, using the signed certificate, a virtual tunnel to communicate with a remote resource; and
updating, by the second device using the remote resource, one or more provisioned resources of the second device.

2. The method of claim 1, wherein:
the first device establishes a shared secret with the one or more servers prior to the first request;
the shared secret expires at a second expiration time; and
a communications channel for the first request is established using the shared secret.

3. The method of claim 1, wherein the provisioned resources comprise a plurality of shared secrets and application installations.

4. The method of claim 1, wherein the communications between the second device and the one or more servers for the API are provided over a public network.

5. The method of claim 1, wherein communicating the second request comprises communicating, by the second device, the second request to the API automatically responsive to an execution of a startup sequence of the second device, the startup sequence comprising a suboperation to prevent an execution of the startup sequence upon a completion of the startup sequence.

6. The method of claim 5, further comprising:
verifying, by the second device, responsive to a second execution of the startup sequence, a state of a plurality of sequential suboperations of the startup sequence to update the one or more provisioned resources; and
resuming, by the second device, responsive to detecting an uncompleted suboperation of the plurality of sequential suboperations, the sequential suboperations to update the one or more provisioned resources.

7. The method of claim 1, further comprising:
retrieving, by the second device, a first portion of the credentials from a non-volatile hardware-embedded unique identifier of an application specific hardware device local to the second device; and
retrieving, by the second device via a network interface from the first device, a second portion of the credentials comprising the unique identifier included in the first request.

8. The method of claim 1, wherein the API determines a status of the signed certificate and reverts the updates to the one or more provisioned resources based on the status.

9. A server, comprising:
one or more processors configured to:
receive, from a first device, a first request comprising a unique identifier, the first request corresponding to an expiration time;
receive from a second device, prior to the expiration time, a credential corresponding to the unique identifier and a second request for a signed certificate; and
issue, responsive to receipt of the credential prior to the expiration time, the signed certificate.

10. The server of claim 9, wherein the one or more processors are further configured to:
establish, over a public network, a virtual tunnel to communicate with the second device; and
update, using the virtual tunnel, one or more provisioned resources of the second device.

11. The server of claim 9, wherein the one or more processors are further configured to:
close, prior to the expiration time, a window for the second request defined according to the first request, responsive to a receipt of the credential; and
log any subsequent requests to sign a certificate.

12. The server of claim 9, wherein the credential comprises a credential of an application-specific hardware device.

13. The server of claim 9, wherein the one or more processors are further configured to:
establish a secure connection, using a shared secret between the first device and the server prior to receipt of the first request.

14. The server of claim 9, wherein the one or more processors are further configured to:
receive, from the second device in a deployed configuration, a third request to renew a certificate; and
provide, to the second device, a second signed certificate responsive to the third request.

15. The server of claim 9, wherein the signed certificate is a mutual transport layer security certificate established between the server and the second device.

16. The server of claim 9, wherein the one or more processors are further configured to:
revoke, prior to a predefined expiration time, the signed certificate of the second device.

17. The server of claim 9, wherein the one or more processors are further configured to:
determine an authorization status of the second device responsive to:
a match between a first and second portion of the credential; and
a revocation status of the credential; and
issue the signed certificate responsive to the authorization status.

18. The server of claim 9, wherein the server comprises:
a device commissioning server configured to communicate with the second device;
a certificate issuance server configured to generate the signed certificate; and
a data repository configured to maintain a record of communication between the device commissioning server and the second device.

19. A system comprising:
a first server comprising one or more first processors configured to:
receive, prior to an expiration of a temporal window between for the first server and a first device, a request from a second device;
forward a signed certificate to the second device, the signed certificate received from a second server responsive to a communication of the request to the second server; and
establish a virtual tunnel to communicate with the second device, wherein the second server comprises one or more second processors configured to generate the signed certificate responsive a receipt of the request from the first server.

20. The system of claim 19, wherein the first device is configured to receive, from the second device:
an automatically generated communication comprising:
the request;
an international globally unique identifier (IGUID); and
a serial number, wherein at least one of the IGUID or the serial number is embedded in an application-specific hardware device of the second device.
